(19) United States
(12) Patent Application Publication
(10) Pub. No.: US 2016/0131815 A1
(43) Pub. Date: May 12, 2016

(54) Light Guide Plate and Backlight Module Having the Same

(71) Applicant: Shenzhen China Star Optoelectronics Technology Co. Ltd., Shenzhen, Guangdong (CN)

(72) Inventor: Yanxue ZHANG, Shenzhen, Guangdong (CN)

(73) Assignee: Shenzhen China Star Optoelectronics Technology Co. Ltd., Shenzhen, Guangdong (CN)

(21) Appl. No.: 14/423,110

(22) PCT Filed: Jan. 9, 2015
(86) PCT No.: PCT/CN2015/070476

§ 371 Date: Feb. 21, 2015

(30) Foreign Application Priority Data
Nov. 7, 2014 (CN) 201410626132.5

(51) Int. Cl. F21V 8/00

(52) U.S. Cl. CPC G02B 6/0036; G02B 6/0091

(57) ABSTRACT

The disclosure is related to a light guide plate, comprising a light incident surface, a light emitting surface, and a bottom surface opposite to the light emitting surface. The light emitting surface connects to the light incident surface. The bottom surface connects to the light incident surface. The light emitting surface comprises a plurality of V-shaped groves disposing along a first direction and a second direction. An intersection angle between the first direction and the second direction is greater than 0 degree and less than or equal to 90 degree. The disclosure is further related to a backlight module.

### TECHNICAL FIELD

The disclosure is related to liquid crystal display technology field, and more particular to a light guide plate and backlight module having the light guide plate.

### RELATED ART

The liquid crystal displays are widely used in laptops, mobile phones, electronic dictionaries and other electronic display devices because of the advantages like thinness, low power consumption and low radiation. In recent years, the operation environments have changed because of the technical improvement on LCD technology filed. People desire to develop a LCD device with higher brightness due to the increasing visual demand under the situation that the frequency of outdoor usage is growing.

The light utilization efficiency needs to be improved for this reason. Among components of the backlight module, the light guide plate (LGP) plays a very important role for increasing the light utilization efficiency of the backlight module. In order to increase the light utilization efficiency of the backlight module, the current design of light guide plate adopts the prism (also known as groove) structure to condense the light. However, the current design of the light-emitting surface of the light guide plate is one dimension structure. The current design can only condense the light on two sides of the light guide plate rather than on four sides. Thus it cannot maximize light utilization efficiency of the backlight plate.

### SUMMARY

In order to solve the problem existing in the current technology, one embodiment of the disclosure provides a light guide plate, comprising: a light incident surface; a light emitting surface connecting to the light incident surface; and a bottom surface opposite to the light emitting surface, the bottom surface connecting to the light incident surface; wherein the light emitting surface comprises a plurality of V-shaped grooves disposed along a first direction and a second direction, an intersection angle between the first direction and the second direction is greater than 0 degree and less than or equal to 90 degree.

In one embodiment, the V-shaped grooves are symmetric grooves.

In one embodiment, the V-shaped grooves are asymmetric grooves.

In one embodiment, the intersection angles between the V-shaped grooves are greater than 0 degree and less than or equal to 90 degree.

In one embodiment, the first direction is perpendicular or inclined relative to the light incident surface.

Another embodiment of the disclosure provides a backlight module, comprising a light source, and a light guide plate comprising a light incident surface, a light emitting surface, a bottom surface opposite to the light emitting surface; wherein the light emitting surface connects to the light incident surface, the bottom surface connects to the light incident surface, and the light source is disposed adjacent to the light incident surface; wherein the light emitting surface comprises a plurality of V-shaped grooves disposed along a first direction and a second direction, and an intersection angle between the first direction and the second direction is greater than 0 degree and less than or equal to 90 degree.

In one embodiment, the V-shaped grooves are symmetric grooves.

In one embodiment, the V-shaped grooves are asymmetric grooves.

In one embodiment, the intersection angles between the V-shaped grooves are greater than 0 degree and less than or equal to 90 degree.

In one embodiment, the first direction is perpendicular or inclined relative to the light incident surface.

According to the light guide plate and the backlight module having the light guide plate of the disclosure, after the light is incident to the plurality of dots on the bottom surface from the light incident surface, the direction of the incident light is changed by the plurality of dots such that the light may propagate forward toward the direction of the light emitting surface. The V-shaped grooves are formed respectively at the two directions. The light emitting surface reflects the light and condenses the light on the four sides of the light emitting surface, and thus the disclosure may maximize light utilization efficiency.

### BRIEF DESCRIPTION OF THE DRAWINGS

The above and other exemplary aspects, features and advantages of certain exemplary embodiments of the present disclosure will be more apparent from the following description taken in conjunction with the accompanying drawings, in which:

FIG. 1 is the perspective view of the light guide plate according to the first embodiment of the present disclosure;

FIG. 2 is the front view of the light incident surface of the light guide plate according to the first embodiment of the present disclosure;

FIG. 3 is the front view of the light incident surface of the light guide plate according to the second embodiment of the present disclosure;

FIG. 4 is the cross-sectional view along the first direction of the light guide plate according to the first embodiment of the disclosure;

FIG. 5 is the cross-sectional view along the second direction of the light guide plate according to the third embodiment of the disclosure; and

FIG. 6 is the lateral view of the light guide plate according to the first embodiment of the disclosure.

### DETAILED DESCRIPTION

The following description with reference to the accompanying drawings is provided to explain the exemplary embodiments of the disclosure. It will be apparent, however, that the disclosure may be practiced by one or more embodiments, and the specific embodiments provided herein cannot be interpreted to limit the disclosure. On the contrary, those embodiments are provided to explain the principle and the application of the disclosure such that those skilled in the art may understand the various embodiments of the disclosure and the various modifications for specific expected application.

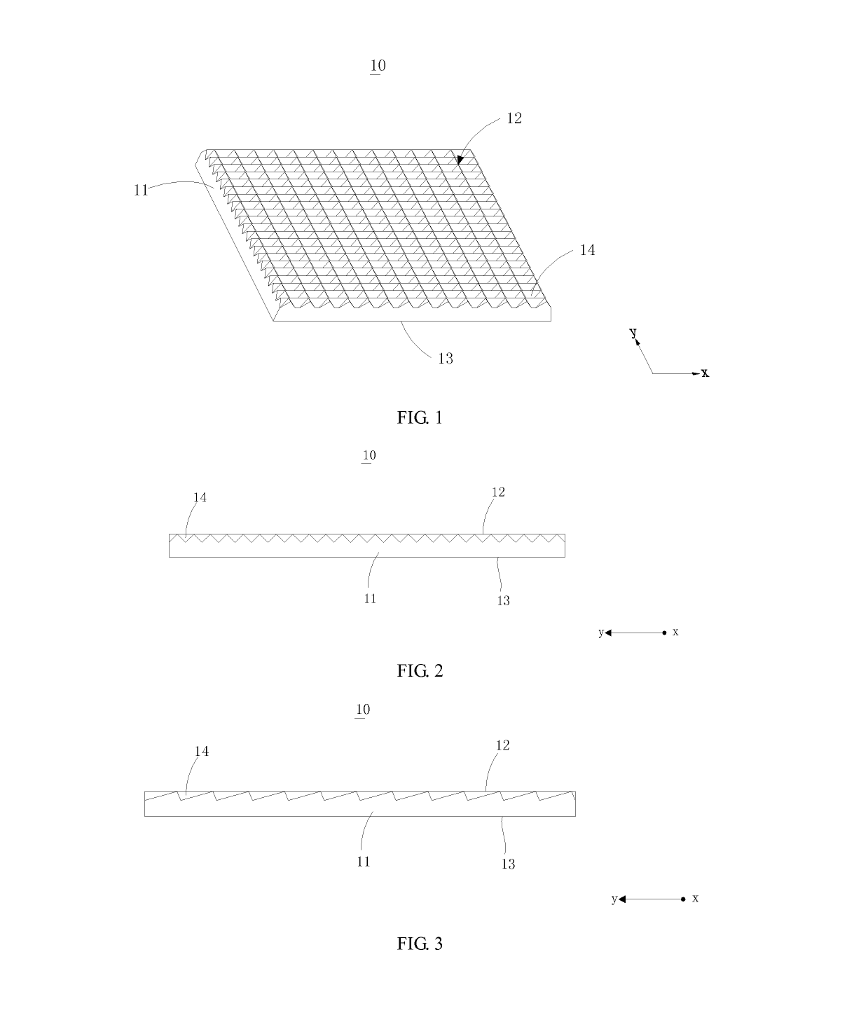

FIG. 1 is the perspective view of the light guide plate according to the first embodiment of the present disclosure.

With reference to FIG. 1, the light guide plate 10 according to the first embodiment of the disclosure comprises: a light incident surface 11, a light emitting surface 12 and a bottom surface 13 opposite to the light emitting surface 12. The light emitting surface 12 connects to the light incident surface 11. The bottom surface 13 connects to the light incident surface 11. The light emitting surface 12 comprises a plurality of V-shaped grooves 14 disposed along a first direction x and a second direction. In this embodiment, an intersection angle between the first direction x and the second direction y in this embodiment is 90 degree, but the present disclosure is not limited thereto. The intersection angle between the first direction x and the second direction y is from 0 to 90 degree in another embodiment of the disclosure.

FIG. 2 is the front view of the light incident surface of the light guide plate according to the first embodiment of the present disclosure. FIG. 3 is the front view of the light incident surface of the light guide plate according to the second embodiment of the present disclosure.

With reference to FIG. 2, the first direction x is perpendicular relative to the light incident surface 11 in the disclosure, but the present disclosure is not limited thereto. The first direction x is inclined relative to the light incident surface in another embodiment of the disclosure.

In one embodiment, the V-shaped grooves 14 disposed along the first direction x are symmetric grooves. In other words, the V-shaped grooves 14 disposed along the first direction x have two equal side, but the present disclosure is not limited thereto. With reference to FIG. 3, the V-shaped grooves 14 disposed along the first direction x are asymmetric grooves in another embodiment of the disclosure. That is to say the V-shaped grooves 14 disposed along the first direction x have two unequal side.

In one embodiment, the intersection angle of two sides of the V-shaped grooves 14 disposed along the first direction x is 90 degree, but the present disclosure is not limited thereto. The intersection angle of two sides of the V-shaped grooves 14 disposed along the first direction x may also be from 0 to 90 degree.

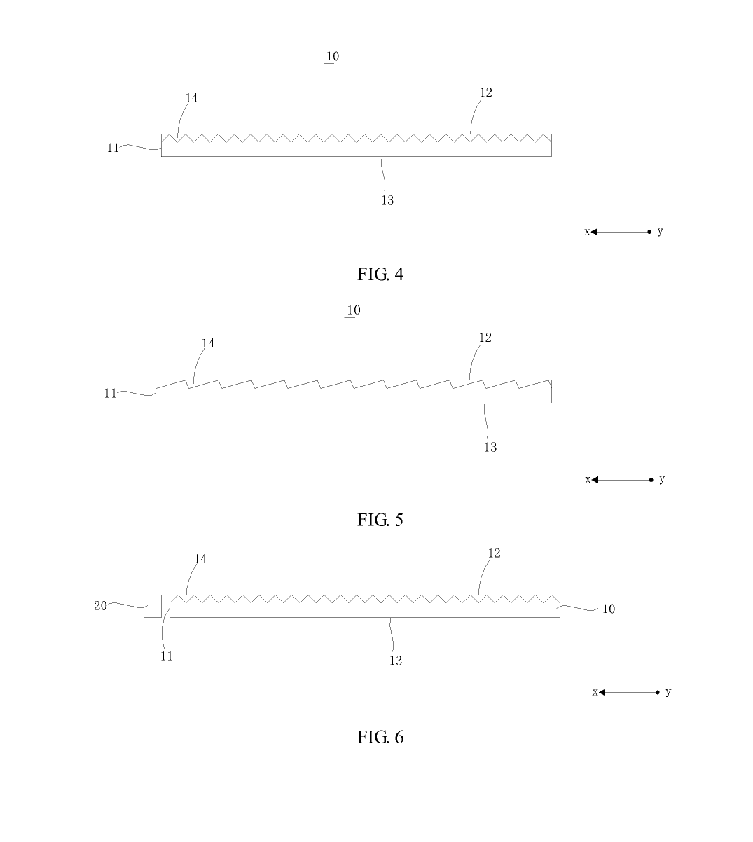

FIG. 4 is the cross-sectional view along the first direction of the light guide plate according to the first embodiment of the disclosure. FIG. 5 is the cross-sectional view along the second direction of the light guide plate according to the third embodiment of the disclosure.

With reference to FIG. 4, the second direction y is parallel to the light incident surface 11 in the disclosure, but the present disclosure is not limited thereto. The second direction y is inclined relative to the light incident surface in another embodiment of the disclosure.

The V-shaped grooves 14 disposed along the second direction y are symmetric grooves. In another word, the V-shaped grooves 14 disposed along the second direction y have two equal side, but the present disclosure is not limited thereto. With reference to FIG. 5, the V-shaped grooves 14 disposed along the second direction y are asymmetric grooves in another embodiment of the disclosure. That is to say the V-shaped grooves 14 disposed along the second direction y have two unequal sides.

The intersection angle of two sides of the V-shaped grooves 14 disposing along the second direction y is 90 degree, but not limitation. The intersection angle of two sides of the V-shaped grooves 14 disposing along the second direction y may also be form the 0 to 90 degree.

In addition, the plurality of dots (not shown) may be formed on the bottom surface 13 of the light guide plate of the first embodiment of the disclosure and make the light to propagate toward the direction of the light emitting surface 12.

After the light is incident to the plurality of dots on the bottom surface 13 from the light incident surface 11, the direction of the incident light is changed by the plurality of dots such that the light may propagate forward toward the direction of the light emitting surface 12. The V-shaped grooves is formed in the both cross direction on the light emitting surface 12. The light emitting surface 12 reflects the light and condenses the light on the four side of the light emitting surface 12, thus can increase for the maximizing light utilization efficiency.

FIG. 6 is the lateral view of the light guide plate according to the first embodiment of the disclosure.

With reference to FIG. 6, the backlight module of the first embodiment of the disclosure comprises: a light source 20 and a light guide plate 10. The light guide plate 10 comprises a light incident surface 11, a light emitting surface 12 and a bottom surface 13 opposite to the light emitting surface. The light emitting surface 12 connects to the light incident surface 11. The bottom surface 13 connects to the light incident surface 11. The light emitting surface 12 comprises a plurality of V-shaped groves 14 disposed along a first direction x and a second direction y. Future, an intersection angle between the first direction x and the second direction y in this embodiment is 90 degree. The light sources 20 is disposed adjacent to the light incident surface 11 and may be Light-Emitting Diodes.

Although the present disclosure is illustrated and described with reference to specific embodiments, those skilled in the art will understand that many variations and modifications are readily attainable without departing from the spirit and scope thereof as defined by the appended claims and their legal equivalents.

1. A light guide plate, comprising:
a light incident surface;
a light emitting surface connecting to the light incident surface; and
a bottom surface opposite to the light emitting surface, the bottom surface connecting to the light incident surface;
wherein the light emitting surface comprises a plurality of V-shaped grooves disposed along a first direction and a second direction, and an intersection angle between the first direction and the second direction is greater than 0 degree and less than or equal to 90 degree,
wherein, for each of the V-shaped grooves, a bottom of the V-shaped groove is wider than a top of the V-shaped groove, and the top of the V-shaped groove is closer to the bottom surface than the bottom of the V-shaped groove.

2. The light guide plate according to claim 1, wherein the V-shaped grooves are symmetric grooves.

3. The light guide plate according to claim 1, wherein the V-shaped grooves are asymmetric grooves.

4. The light guide plate according to claim 2, wherein intersection angles between the V-shaped grooves are greater than 0 degree and less than or equal to 90 degree.

5. The light guide plate according to claim 3, wherein intersection angles between the V-shaped grooves are greater than 0 degree and less than or equal to 90 degree.

6. The light guide plate according to claim 1, wherein the first direction perpendicular or inclined relative to the light incident surface.

7. A backlight module, comprising:
a light source; and
a light guide plate comprises:
a light incident surface, the light source disposing near the light incident surface;
a light emitting surface connecting to the light incident surface; and
a bottom surface opposite to the light emitting surface, the bottom surface connecting to the light incident surface;
wherein the light emitting surface comprises a plurality of V-shaped grooves disposing along a first direction and a second direction, and an intersection angle between the first direction and the second direction is greater than 0 degree and less than or equal to 90 degree,
wherein, for each of the V-shaped grooves, a bottom of the V-shaped groove is wider than a top of the V-shaped groove, and the top of the V-shaped groove is closer to the bottom surface than the bottom of the V-shaped groove.

8. The backlight module according to claim 7, wherein the V-shaped grooves are symmetric grooves.

9. The backlight module according to claim 7, wherein V-shaped grooves are asymmetric grooves.

10. The backlight module according to claim 8, wherein intersection angles between the V-shaped grooves are greater than 0 degree and less than or equal to 90 degree.

11. The backlight module according to claim 9, wherein intersection angles between the V-shaped grooves are greater than 0 degree and less than or equal to 90 degree.

12. The backlight module according to claim 7, wherein the first direction is perpendicular or inclined relative to the light incident surface.
